(19) United States
(12) Patent Application Publication
(10) Pub. No.: US 2009/0101829 A1
(43) Pub. Date: Apr. 23, 2009

(54) SENSOR, SYSTEM, AND METHOD FOR AN ULTRAVIOLET LAMP SYSTEM

(75) Inventors: James W. Schmitkons, Lorain, OH (US); James C. Smith, Amherst, OH (US); Paul Weyandt, Willoughby, OH (US)

Correspondence Address: WOOD, HERRON & EVANS, LLP (NORDSON), 2700 CAREW TOWER, 441 VINE STREET, CINCINNATI, OH, 45202, US

(73) Assignee: NORDSON CORPORATION, Westlake, OH (US)

(21) Appl. No.: 11/875,363

(22) Filed: Oct. 19, 2007

(51) Int. Cl. G01J 5/08

(52) U.S. Cl. 250/372; 250/227.11

(57) ABSTRACT

A light sensor for an ultraviolet lamp system of the type having an electrodeless lamp excited by microwave energy includes a detector configured to detect light generated by the electrodeless lamp. An elongated channel is configured to be interposed between the detector and the electrodeless lamp. The elongated channel has a first aperture and a second aperture defined at opposing ends thereof. The first aperture is configured to receive light generated by the electrodeless lamp. The second aperture is positioned proximate the detector to transmit at least a portion of light received in the first aperture to the detector.

### FIELD OF THE INVENTION

The present invention relates generally to ultraviolet lamp systems and, more particularly, to detection of light from ultraviolet lamp systems.

### BACKGROUND OF THE INVENTION

Ultraviolet (“UV”) lamp systems are commonly used for heating and curing materials such as adhesives, sealants, inks, and coatings. Certain ultraviolet lamp systems have electrodeless light sources and operate by exciting an electrodeless plasma lamp (“bulb”) with microwave energy. In an electrodeless ultraviolet lamp system that relies upon excitation with microwave energy, the bulb is mounted within a metallic microwave cavity or chamber. One or more microwave generators, such as magnetrons, are coupled via waveguides with the interior of the microwave chamber. The magnetrons supply microwave energy to initiate and sustain a plasma from a gas mixture enclosed in the bulb. The plasma emits a characteristic spectrum of electromagnetic radiation strongly weighted with spectral lines or photons having ultraviolet and infrared wavelengths.

The bulb in an electrodeless UV lamp system lights when excited by microwave energy and has no direct electrical connections to the other portions of the lamp system. Therefore, a light sensor in the microwave cavity is used to determine if the bulb is lit. Without the light sensor, the UV lamp system has no indication of the status of the bulb (on or off). Conventional light sensors detect light intensity inside the lamp box but are not oriented directly at the bulb. However, in some applications, another lamp may be positioned such that it shines enough light into the cavity to activate the light sensor and cause it to falsely indicate that the bulb is lit.

One method to reduce the false detections from stray light sources has been to place the light sensor in the microwave chamber and orient it such that it is directed toward the bulb. This method reduces the effects of incoming light from other sources; however, this method also exposes the light sensor to very intense UV light that must be reduced to a level compatible with the sensor's operating range. In some instances, colored glass filters have been used to reduce the intensity, though with extended exposure to the intense UV light, these filters often change or cloud over and this can adversely affect the calibration of the light sensors. Additionally, at sufficient intensities, incoming light from external sources can still activate the sensor.

Another method used to avoid the challenges with filters is to direct the light sensor at a highly polished surface and detect the reflected light from the bulb. While this method may help in overcoming some of the challenges with the sensor oriented directly toward the bulb, it still can produce false detections if external light is also reflected from the highly polished surface.

### SUMMARY OF THE INVENTION

A light sensor is provided for an ultraviolet lamp system of the type having an electrodeless lamp excited by microwave energy. The light sensor includes an elongated channel having a first aperture and a second aperture. The first aperture is directed generally toward the electrodeless lamp. The second aperture is configured to receive at least a portion of light received in the first aperture and transmit it to a detector. The light received in the first aperture typically includes ultraviolet, visible, and infra-red components. In one embodiment of the light sensor, the elongated channel includes a first elongated channel portion and a second elongated channel portion. The first elongated channel portion is oriented generally transverse to the second elongated channel portion, such that the first elongated channel portion and the second elongated channel portion are not in a direct line of sight. The detector for this embodiment includes light detection circuitry that is configured to detect light reflected in the second elongated channel portion at the second aperture.

In an alternate embodiment of the light sensor, a lens intersects the elongated channel and is positioned between the first aperture and the second aperture. The lens allows infrared radiation to pass through while substantially blocking visible light. In this embodiment, the detector includes infrared detection circuitry that is configured to detect infrared radiation in the elongated channel at the second aperture.

### BRIEF DESCRIPTION OF THE DRAWINGS

The accompanying drawings illustrate embodiments of the invention and, together with a general description of the invention given above, and the detailed description given below, serve to explain the principles of the invention.

FIG. 1 is a block diagram of an ultraviolet lamp system incorporating a light sensor.

FIG. 2 is a perspective view of the light sensor in FIG. 1 illustrating an aperture facing the bulb and an aperture used to detect the light.

FIG. 3 is a top plan view of the light sensor in FIG. 2.

FIG. 4 is a cross sectional view of the light sensor in FIG. 3 taken along line 4-4.

FIG. 5 is a cross sectional view of an alternative embodiment of the light sensor in FIG. 1.

FIG. 6 is a cross sectional view of another alternative embodiment of the light sensor in FIG. 1

FIG. 7 is a detailed view of a portion of the ultraviolet lamp system in FIG. 1.

FIG. 8 is a cross sectional view of another alternative embodiment of the light sensor in FIG. 1.

### DETAILED DESCRIPTION

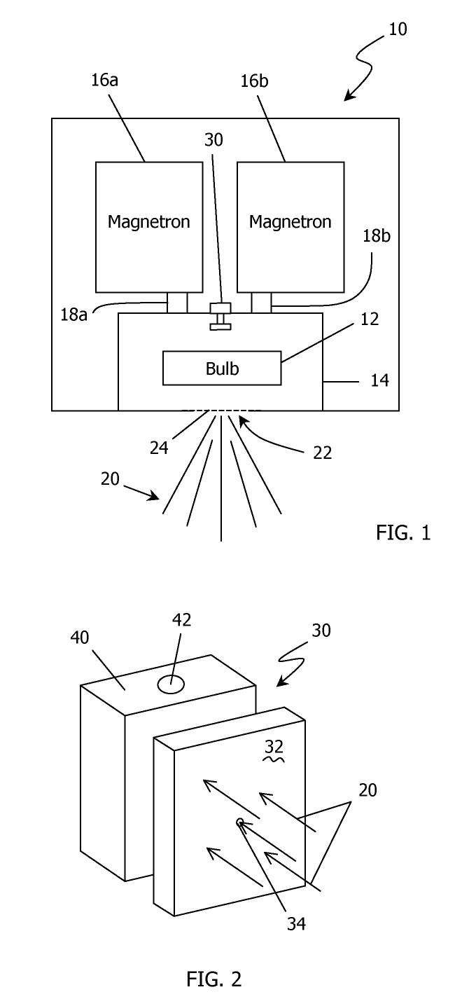

Referring now to the drawings where like numbers denote like components among the several views, FIG. 1 is a block diagram of an ultraviolet lamp system 10 that relies upon excitation of an electrodeless lamp or bulb 12 with microwave energy. The bulb 12 is mounted within a metallic microwave chamber 14. One or more magnetrons 16a, 16b are coupled via waveguides 18a, 18b with the interior of the microwave chamber 14. The magnetrons 16a, 16b supply microwave energy to the bulb 12 in order to generate ultraviolet light 20. The ultraviolet light 20 is directed from the microwave chamber 14 through a chamber outlet 22 to an external location through a fine-meshed metal screen 24 which covers the chamber outlet 22 and is capable of blocking emission of microwave energy, while allowing the ultraviolet light 20 to be transmitted outside the microwave chamber 14. A light sensor 30 is positioned, at least in part, in the microwave chamber 14 in order to detect the ultraviolet light 20 produced by the bulb 12. In some embodiments, the entire light sensor 30 is placed inside the microwave chamber 14. In other embodiments, only a portion of the sensor 30 is in the chamber 14 or at least in communication with the chamber 14.

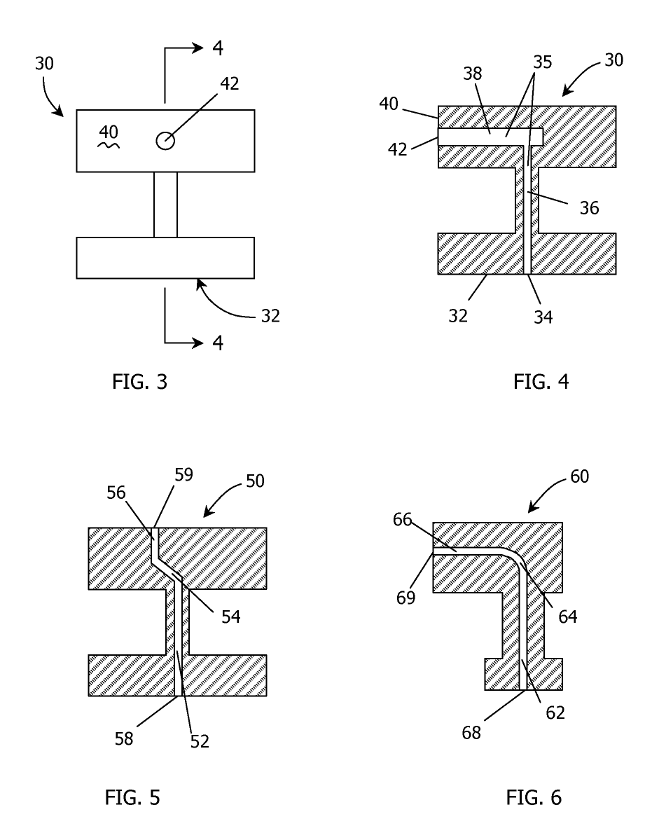

Referring now to FIGS. 2-4, an exemplary configuration of the light sensor 30 has a front face 32 defining a first aperture 34, which faces the bulb 12. The first aperture 34 begins an elongated channel 35, which terminates at a second aperture 42. In this embodiment, the elongated channel 35 includes a first elongated channel portion 36 that extends partially through the light sensor 30. The first elongated channel portion 36 is generally transverse to and intersects with a second elongated channel portion 38, which extends toward an external face 40 terminating at the second aperture 42. The first elongated channel portion 36 and the second elongated channel portion 38 are oriented such that the first and second apertures are not in a direct line of sight with each other. In this embodiment, the first and second elongated channel portions 36, 38 are linear, though in other embodiments, channel portions may be linear, curvilinear, or combinations of both. Additionally, other orientations of the first and second channel portions 36, 38 in other embodiments may range from orientations where the first and second apertures 34, 42 are in a direct line of sight with each other to orientations where the first and second channel portions 36, 38 form an acute angle with respect to one another. In some embodiments, the first and second channel portions 36, 38 are substantially perpendicular. In other embodiments, the first and second channel portions 36, 38 are configured to form a U-shape, a V-shape, or other shapes.

Additional channel portions may also be connected with channel portions 36, 38 as illustrated in the embodiments shown in FIGS. 5 and 6. With respect to FIG. 5, the sensor 50 contains three channel portions 52, 54, 56. In this embodiment, the channel portions also do not form a direct line of sight between first and second apertures 58, 59. The second channel portion 54 forms two doglegs with the first 52 and third 56 channel portions, thereby reducing the likelihood of transmitting stray light from external sources. An alternate configuration of the sensor 60 shown in FIG. 6 is also composed of three channel portions 62, 64, 66, where the second channel portion 64 is curvilinear in shape and positioned such that apertures 68, 69 are also not in a direct line of sight with each other.

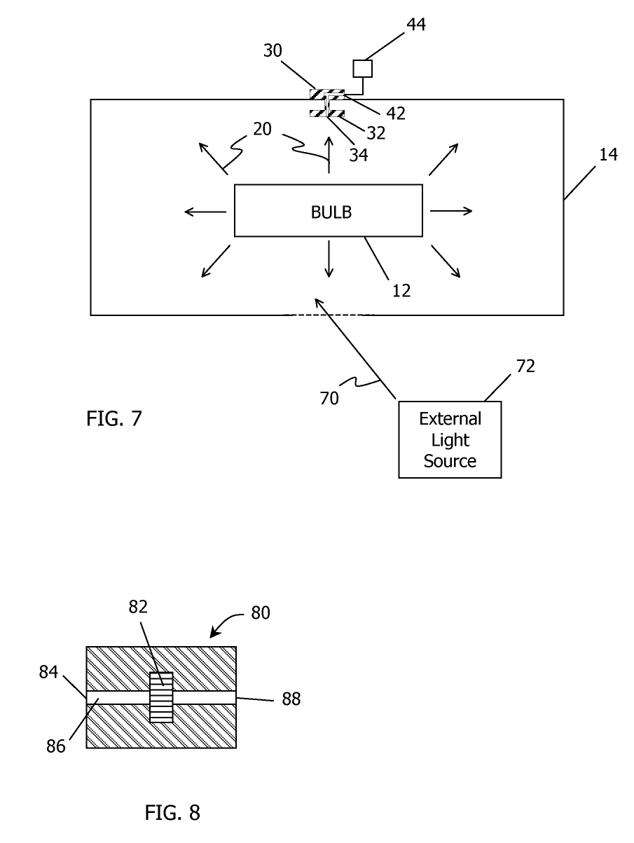

As illustrated in FIG. 7 and referencing the embodiment shown in FIGS. 2-4, UV light 20 enters the first aperture 34 and travels down the first elongated channel portion 36. The light 20 is reflected in the second elongated channel portion 38. Detection circuitry 44 is positioned at the second aperture 42 and is configured to detect the reflected light in the second elongated channel portion 38. The detection circuitry 44 communicates the status of the bulb (on or off) to the UV Lamp system 10. By virtue of the fact that apertures 34, 42 are not in a direct line of sight with each other, detection circuitry 44 is similarly not in a direct line of sight with bulb 12, and as such, the intensity of light to which circuitry 44 is subjected is attenuated to a level that is within the operation range of circuitry 44.

Sizes of the apertures and channels in some embodiments range, for example, from approximately 0.5 mils to approximately 10 mils. These sizes may be larger or smaller in other embodiments as appropriate for the channel lengths and light intensities of those embodiments. The sizes and configurations of the channel portions are dependent on the range of the detector circuitry 44. For example, in the present embodiment the first and second channel portions 36, 38 may have different sized cross sections to accommodate the detection range of the detector circuitry 44. The cross sections of the channel portions 36, 38 may be the same for other embodiments. Similarly, the first and second channel portions 36, 38, in some embodiments, intersect each other at the ends opposite the first and second apertures 34, 42, or as with this embodiment, the first channel portion 36 intersects the second channel portion 38 between the second aperture 42 and the end of the second channel portion 38 opposite the second aperture 42.

The light sensor 30 may be positioned anywhere in the microwave chamber 14 as long as it can be oriented generally toward the bulb. Positioning the light sensor 30 such that it is not directly in line with the chamber outlet 22 assists in reducing the number of false detections. In addition, while stray light 70 from an external light source 72 is able to enter the microwave chamber 14 through the chamber outlet 22, elongated channel 35 in the light sensor 30 assists in attenuating the stray light 70 from the external light source 72. This in turn also assists in reducing the number of false detections.

Another embodiment of the light sensor 80, illustrated in FIG. 8, uses a lens 82 composed of silicon or germanium. Infrared radiation is allowed to pass through the lens 82 but visible light is blocked. UV light and infrared radiation produced from the bulb 12 as well as stray light 70 from external light sources 72 enters the light sensor 80 through a first aperture 84 and travels down an elongated channel 86. The UV light and stray visible light are blocked by the lens 82, which allows only the infrared radiation to pass through as stated above. Detection circuitry (not shown), configured to detect infrared radiation, is positioned at a second aperture 88 and communicates the status of the bulb 12 (on or off) to a control of the UV lamp system 10. While the first and second apertures 84, 88 are positioned in a direct line of sight with each other; other embodiments utilizing the lens may position the first and second apertures 84, 88 out of a direct line of sight with each other.

The light sensor, in some embodiments, is machined from a block of aluminum. The walls of the channel (or channel portions) do not require a specific reflectivity; however, the wall properties should not degrade or change over time, as that would change the light input to the sensor, possibly causing the sensor output to be unreliable. The reflectivity of the channel walls may be a design parameter that is considered when the detection circuitry is selected. If a certain reflectivity is required, the walls can be treated by, for example, a gold plating or Teflon coating, though any type of reflective coating that would tolerate the harsh conditions of the environment could be used.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described, for example, other embodiments of the light sensor may utilize combinations of the first and second elongated channel portions in the embodiment in FIGS. 2-4, the first, second and third elongated channel portions in the embodiments in FIGS. 5 and 6, and the lens in the embodiment in FIG. 6. The various features disclosed herein may be used alone or in any combination depending on the needs of the application. Accordingly, departures may be made from such details without departing from the spirit or scope of applicants' general inventive concept.

What is claimed is:

1. A light sensor for an ultraviolet lamp system of the type having an electrodeless lamp excited by microwave energy to provide light for irradiating a substrate, the light sensor comprising:
a detector operative to detect light generated by the electrodeless lamp; and
an elongated channel configured to be interposed between said detector and the electrodeless lamp, said elongated channel including a first aperture and a second aperture defined at opposing ends thereof, said first aperture configured to receive light generated by the electrodeless lamp and said second aperture positioned proximate said detector to transmit at least a portion of light received in said first aperture to said detector.

2. The light sensor of claim 1 wherein said elongated channel comprises:
a first elongated channel portion in communication with a second elongated channel portion, said first elongated channel portion positioned relative to said second elongated channel portion such that said first and second apertures are not in a direct line of sight with each other.

3. The light sensor of claim 2 wherein said first elongated channel is oriented generally transverse to said second elongated channel.

4. The light sensor of claim 2 wherein said elongated channel further comprises:
a third elongated channel portion in communication with said second elongated channel portion, said third elongated channel portion positioned relative to said second elongated channel portion such that said first and second apertures are not in a direct line of sight with each other.

5. The light sensor of claim 4 wherein said first elongated channel portion is oriented generally parallel to said third elongated channel portion.

6. The light sensor of claim 1 further comprising:
a lens intersecting said elongated channel and positioned between said first aperture and said second aperture,
wherein said lens allows infrared radiation to pass through while blocking visible light.

7. The light sensor of claim 6 wherein said detector comprises:
infrared detection circuitry configured to detect infrared radiation in said elongated channel.

8. The light sensor of claim 6 wherein said lens comprises silicon.

9. The light sensor of claim 6 wherein said lens comprises germanium.

10. The light sensor of claim 6 wherein said elongated channel comprises:
a first elongated channel portion in communication with a second elongated channel portion, said first elongated channel portion positioned relative to said second elongated channel portion such that said first and second apertures are not in a direct line of sight with each other.

11. The light sensor of claim 10 wherein said first and second elongated channel portions are oriented transverse to each other.

12. An ultraviolet lamp system for irradiating a substrate, comprising:
a magnetron;
an electrodeless lamp configured to emit light to irradiate the substrate when excited by microwave energy generated from said magnetron; and
a light sensor for detecting light emitted from said electrodeless lamp, the light sensor including:
a detector operative to detect light generated by the electrodeless lamp; and
an elongated channel configured to be interposed between said detector and said electrodeless lamp, said elongated channel having a first aperture and a second aperture defined at opposing ends thereof, said first aperture configured to receive light generated by said electrodeless lamp and said second aperture positioned proximate said detector to transmit at least a portion of light received in said first aperture to said detector.

13. The ultraviolet lamp system of claim 12 wherein said elongated channel comprises:
a first elongated channel portion in communication with a second elongated channel portion, said first elongated channel portion positioned relative to said second elongated channel portion such that said first and second apertures are not in a direct line of sight with each other.

14. The ultraviolet lamp system of claim 13 wherein said first elongated channel is oriented generally transverse to said second elongated channel.

15. The ultraviolet lamp system of claim 13 wherein said elongated channel further comprises:
a third elongated channel portion in communication with said second elongated channel portion, said third elongated channel portion positioned relative to said second elongated channel portion such that said first and second apertures are not in a direct line of sight with each other.

16. The ultraviolet lamp system of claim 15 wherein said first elongated channel portion is oriented generally parallel to said third elongated channel portion.

17. The ultraviolet lamp system of claim 12 wherein said light sensor further comprises:
a lens intersecting said elongated channel and positioned between said first aperture and said second aperture,
wherein said lens allows infrared radiation to pass through while blocking visible light.

18. The ultraviolet lamp system of claim 17 wherein said detector comprises:
infrared detection circuitry configured to detect infrared radiation in said elongated channel.

19. The ultraviolet lamp system of claim 17 wherein said elongated channel comprises:
a first elongated channel portion in communication with a second elongated channel portion, said first elongated channel portion positioned relative to said second elongated channel portion, such that said first and second apertures are not in a direct line of sight with each other.

20. The ultraviolet lamp system of claim 19 wherein said first and second elongated channel portions are oriented transverse to one another.

21. A method of operating an ultraviolet lamp system, the method comprising:
emitting ultraviolet light within a chamber from an electrodeless lamp excited with microwave energy generated by a magnetron;
irradiating a substrate in the chamber with the ultraviolet light;
receiving a portion of the emitted ultraviolet light in an elongated channel communicating with the chamber;
detecting the received portion of the emitted ultraviolet light with detection circuitry communicating with the elongated channel; and
electrically communicating an output of the detection circuitry to a control of the ultraviolet lamp system, wherein the output represents an amount of detected ultraviolet light.

22. The method of claim 21 further comprising:
reducing an intensity of the portion of the emitted ultraviolet light received in the elongated channel.

23. The method of claim 22 further comprising:
receiving a portion of stray visible light emitted from an external source in the elongated channel; and
reducing an intensity of the portion of the stray visible light received in the elongated channel.

24. A method of operating an ultraviolet lamp system, the method comprising:
emitting ultraviolet light and infrared radiation within a chamber from an electrodeless lamp excited with microwave energy generated by a magnetron;
irradiating a substrate in the chamber with the ultraviolet light;
receiving a portion of the emitted ultraviolet light and infrared radiation in an elongated channel communicating with the chamber;
substantially blocking the portion of emitted ultraviolet light by a lens intersecting the elongated channel;
detecting the received portion of the emitted infrared radiation with detection circuitry communicating with the elongated channel; and
electrically communicating an output of the detection circuitry to a control of the ultraviolet lamp system, wherein the output represents an amount of detected infrared radiation.

25. The method of claim 24 further comprising:
receiving a portion of stray visible light emitted from an external source in the elongated channel; and
substantially blocking the portion of stray visible light by the lens intersecting the elongated channel.
